(19) United States
(12) Patent Application Publication
(10) Pub. No.: US 2012/0008356 A1
(43) Pub. Date: Jan. 12, 2012

(54) CURRENT-FED CONVERTER

(75) Inventors: Teuvo SUNTIO, Ylojarvi (FI); Lari NOUSIAINEN, Tampere (FI)

(73) Assignee: ABB Oy, Helsinki (FI)

(21) Appl. No.: 13/180,252

(22) Filed: Jul. 11, 2011

(30) Foreign Application Priority Data
Jul. 12, 2010 (EP) 10169229.1

(51) Int. Cl. H02M 7/537; G05F 1/00

(52) U.S. Cl. 363/131; 323/271

(57) ABSTRACT

A converter circuit includes first and second input terminals for receiving input current from a current source, a first capacitor connected between the first and second input terminals, a second capacitor having a first terminal of which is connected to the second input terminal and a second terminal which forms a positive voltage node, and first and third semiconductor components connected in series between the first input terminal and a positive voltage node, where the midpoint between the series connection forms a first node. The converter circuit includes first inductive component connected between the second input terminal and first node, second and fourth semiconductor components connected in series in parallel with the series connection first and third semiconductor components, a second inductive component having a first end which is connected to a second node formed between the second and fourth semiconductor components and a second end which produces a first output terminal, where the second output terminal is formed of the first input terminal. The first and the third semiconductor components are configured to control the voltage between the first and second input terminals.

### RELATED APPLICATION

This application claims priority under 35 U.S.C. §119 to European Patent Application No. 10169229.1 filed in Europe on Jul. 12, 2010, the entire content of which is hereby incorporated by reference in its entirety.

### FIELD

The present disclosure relates to converters, and more particularly, to current-fed converters.

### BACKGROUND INFORMATION

Converters are common electric apparatuses that are used for converting electricity from one form to another. Converters are used for rising or lowering voltage or current levels to adapt the voltage of a source to the voltage of the load.

Converters are also used in connection with photovoltaic (PV) panels for supplying the power available from the panels. The power may be supplied directly to an alternating voltage network, to a DC-voltage bus or to a power consuming load. Depending on the amount of PV cells or panels connected for supplying power, the voltage is either rised or lowered for supplying the load with appropriate voltage.

In connection with the PV systems, the converter system also keeps the operating point of the panel at its maximum power point. A PV panel has a certain operating point at which the extracted power has its maximum. A maximum power point tracker (MPPT) calculates the operating point from the measured current and voltage of the panel and gives a reference value for either output voltage or current of the panel. The control system of the converter controls the actual output value of the panel to the reference, and the maximum available power is obtained from the panel. The MPPT calculates continuously the reference value and the control system adapts to this situation enabling continuous operation in the maximum power point regardless of the varying operating conditions.

Converter topologies can be roughly divided into current fed and voltage fed converters. In voltage fed converters, the power source feeds a voltage to the input of the converter. In current fed converters, the source feeds current to the input. Due to the constant-current nature of PV panels, the optimal interfacing of the panels can be implemented by using current fed converters. A current fed converter can operate within the whole range of the UI curve of the panel from the short-circuit to open-circuit conditions. In voltage-fed converters, the operation can only be carried out at the voltages equal or higher than the maximum power point voltage.

### SUMMARY

An exemplary embodiment provides a converter circuit which includes first and second input terminals for receiving an input current from a current source, and a first capacitor connected between the first and second input terminals. The exemplary converter circuit also includes a second capacitor having a first terminal connected to the second input terminal, and a second terminal forming a positive voltage node. In addition, the exemplary converter circuit includes first and third semiconductor components connected in series between the first input terminal and a positive voltage node, where a midpoint between the series connection forms a first node. The exemplary converter circuit also includes a first inductive component connected between the second input terminal and the first node, and second and fourth semiconductor components connected in series in parallel with the series connection between the first and third semiconductor components. In addition, the exemplary converter circuit includes a second inductive component having a first end which is connected to a second node formed between the second and fourth semiconductor components, and a second end which forms a first output terminal, where the first input terminal forming a second output terminal. The first and the third semiconductor components are configured to control a voltage between the first and second input terminals.

An exemplary embodiment provides a method for controlling a converter. The converter includes first and second input terminals for receiving an input current from a current source, and a first capacitor connected between the first and second input terminals. The converter also includes a second capacitor having a first terminal connected to the second input terminal, and a second terminal forming a positive voltage node. In addition, the converter includes first and third semiconductor components connected in series between the first input terminal and a positive voltage node, where a midpoint between the series connection forms a first node. The converter also includes a first inductive component connected between the second input terminal and the first node, and second and fourth semiconductor components connected in series in parallel with the series connection between the first and third semiconductor components. In addition, the converter includes a second inductive component having a first end which is connected to a second node formed between the second and fourth semiconductor components, and a second end which forms a first output terminal, where the first input terminal forming a second output terminal. The exemplary method includes measuring the input current and an input voltage, and generating a voltage reference for the input voltage. In addition, the exemplary method includes controlling the first and third semiconductor components in response to the measured voltage and voltage reference.

### BRIEF DESCRIPTION OF THE DRAWINGS

Additional refinements, advantages and features of the present disclosure are described in more detail below with reference to exemplary embodiments illustrated in the drawings, in which:

FIG. 1 illustrates main circuit of a converter according to an exemplary embodiment of the present disclosure;

FIG. 2 shows the converter of FIG. 1 with current and voltage definitions according to an exemplary embodiment of the present disclosure;

FIG. 3 shows the on-time circuit structure of the converter according to an exemplary embodiment of the present disclosure;

FIG. 4 shows the off-time circuit structure of the converter according to an exemplary embodiment of the present disclosure;

FIG. 5 shows approximate waveforms of voltages and currents according to an exemplary embodiment of the present disclosure;

FIG. 6 shows the on-off-time circuit structure of the converter according to an exemplary embodiment of the present disclosure;

FIG. 7 shows the off-on-time circuit structure of the converter according to an exemplary embodiment of the present disclosure;

FIG. 8 shows an example of duty ratio and switch control signal generation according to an exemplary embodiment of the present disclosure;

FIG. 9 shows approximate waveforms when d1>d2 according to an exemplary embodiment of the present disclosure;

FIG. 10 shows approximate waveforms when d1<d2 according to an exemplary embodiment of the present disclosure;

FIG. 11 shows the main circuit setup of the converter according to an exemplary embodiment of the present disclosure;

FIG. 12 shows switching frequency averaged capacitor voltages at the grid connected operation according to an exemplary embodiment of the present disclosure;

FIG. 13 shows switching frequency averaged inductor currents at the grid connected operation according to an exemplary embodiment of the present disclosure; and

FIG. 14 shows waveforms of the grid variables according to an exemplary embodiment of the present disclosure.

### DETAILED DESCRIPTION

Exemplary embodiments of the present invention provide a current fed converter structure having low losses and a wide input voltage range.

Exemplary embodiments of the present disclosure are based on the idea of using a current fed converter structure having a new topology. In accordance with exemplary embodiments, the converter of the present disclosure has a wide conversion ratio in view of the duty ratio of the converter. The topology of the converter can be used to extract the maximum power from a power source, such as a photovoltaic panel. The topology can be used for supplying voltage to a DC bus or with back end inverter to an alternating voltage grid.

In accordance with an exemplary embodiment of the converter, when connected via an inverter part to the grid, the power fluctuations at twice the grid frequency are not visible at the input terminals of the converter, thus reducing the problems relating to the fluctuation of the PV panel operating point.

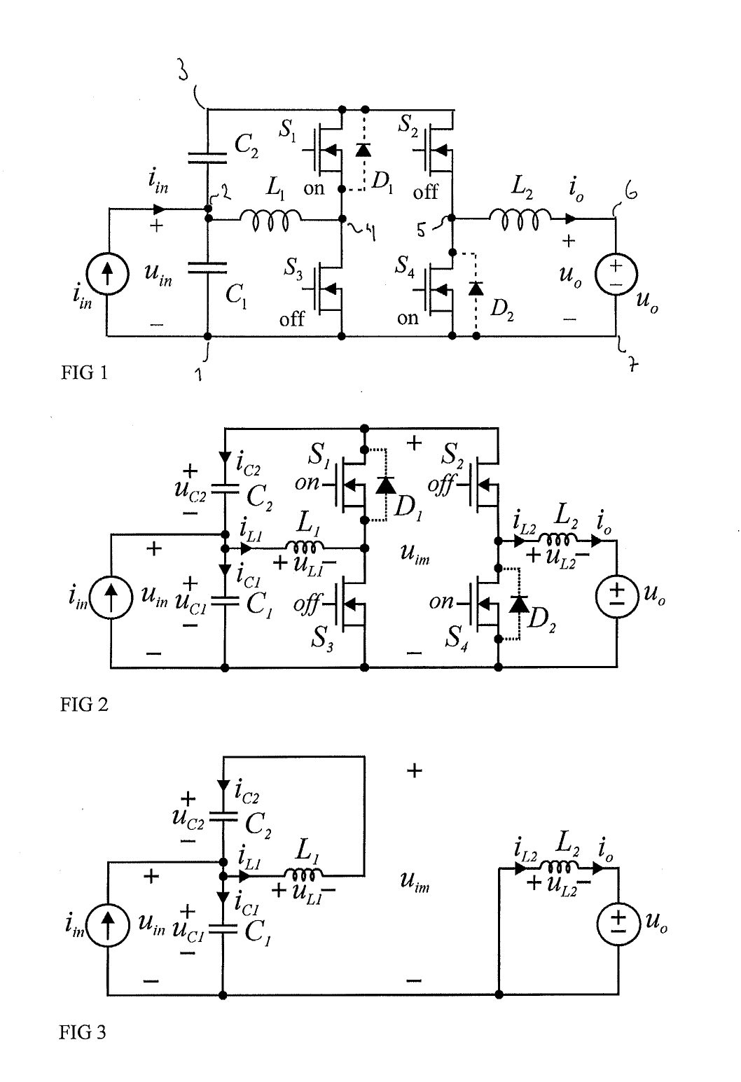

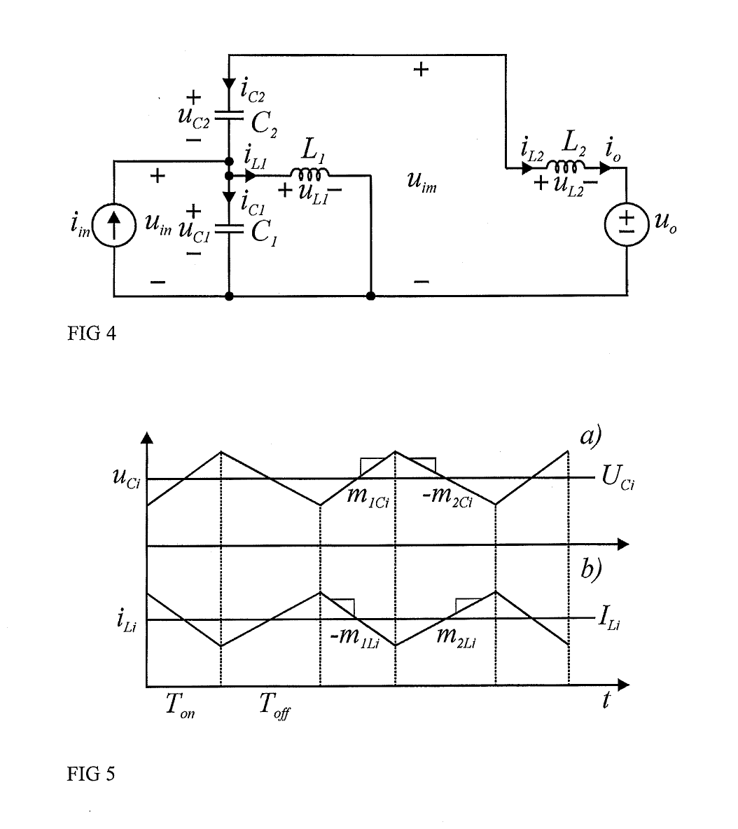

FIG. 1 shows the circuit diagram of a current-fed superbuck-boost converter according to an exemplary embodiment of the present disclosure. In FIG. 1, a current source is connected between first and second input terminals 1, 2 in parallel with a capacitor C₁. Another capacitor C₂ is connected to the second input terminal, and the other terminal of the capacitor C₂ forms a positive voltage node 3.

The converter also includes a series connection of first and third semiconductor components S₁, S₃. The series connection is connected between the first input terminal 1 and the positive voltage node 3. In accordance with an exemplary embodiment, the first semiconductor component can be either a controlled switch component, such as a FET-component, or a diode. The diode D₃ is illustrated in FIG. 1 in dashed line and as mentioned, diode D₃ can be substituted for the switch component S₁. The third semiconductor component is a controlled switch component. The polarities of the components are such that when turned on, the current can flow through the components from the positive voltage node towards the first input terminal, and as a result, the voltage from the positive voltage node is blocked.

The midpoint between the semiconductor components S₁ and S₃ is denoted as the first node 4 for simplicity of description. A first inductive component L₁ is connected between the second input terminal 2 and the first node 4.

Further, the converter of FIG. 1 includes second and fourth semiconductor components S₂, S₄ connected in series. The series connection is connected in parallel with the first and third semiconductor components with similar polarities. As with the first and third semiconductors, both the components S₂ and S₄ may be controlled switches. As indicated in FIG. 1, the fourth switch may be replaced with a diode D₄.

A first end of a second inductive component L₂ is connected to the node between the second and fourth semiconductor components (second node 5). The second end 6 of the second inductive component L₂ is the first output terminal of the converter, while the second output terminal 7 is formed of the first input terminal.

According to an exemplary embodiment of the present disclosure, the first and third semiconductor components are configured to control the voltage uᵢₙ between the first and second input terminals 1 and 2, e.g., the input voltage. Since the converter is a current fed converter, the input current to the converter depends on the supplying source, and the voltage is controlled with the switches to the voltage that suits the operation best.

The current-fed superbuck-boost converter shown in FIG. 1 has steady-state conversion ratios such that the input current (Iᵢₙ) is reflected to the output (Iₒ) multiplied by the duty ratio and divided by its complement (i.e., M(D)=D/D′) and the output voltage (Uₒ) to the input (U)ₙ with the sa me conversion ratio. The converter is a combination of buck (S₁, S₃) and boost (S₂, S₄) type-converters which can be controlled either separately (dual PWM mode) or together (single PWM mode). In the following, the operation of the converter is first studied in the single PWM mode operation and then in the dual PWM mode operation.

### Single PWM Mode

The power stage of the current-fed superbuck-boost converter is shown in FIG. 2 with the defined components and the polarities of relevant currents and voltages. As mentioned above, the on-time switches S₁ and S₄ can also be substituted with diodes D₁ and D₂.

During the on-time, the switches S₂ and S₃ are off and the switches S₁ and S₄ are conducting, yielding the on-time circuit structure given in FIG. 2. During the off-time, the switches S₂ and S₃ are conducting and the switches S₁ and S₄ are off, yielding the off-time circuit structure given in FIG. 3.

During the on-time we can calculate applying Kirchhoff's laws that

u_{L1}=−u_{C2}

u_{L2}=−uₒ

i_{C1}=iᵢₙ

i_{C2}=i_{L1}

uᵢₘ=u_{C1}+u_{C2}

uᵢₙ=u_{C1}

iₒ=i_{L2} (1)

During the off-time we can calculate applying Kirchhoff's laws that

u_{L1}=−u_{C1}

u_{L2}=u_{C1}+u_{C2}−uₒ

i_{C1}=iᵢₙ−i_{L1}−i_{L2}

i_{C2}=−i_{L2}

uᵢₘ=u_{C1}+u_{C2}

uᵢₙ=u_{C1}

iₒ=i_{L2} (2)

According to (1) and (2), the average voltages across the inductors and average currents through the capacitors as well as the average input voltage, intermediate voltage uₕ, (e.g., the voltage of the series connection of capacitors C₁ and C₂) and output current become

[symbol]

u_{L1} [symbol] =(1−d) [symbol] u_{C1} [symbol] −d [symbol] u_{C2}

[symbol]

[symbol]

u_{L2} [symbol] =(1−d) [symbol] u_{C1} [symbol] +(1−d) [symbol] u_{C2} [symbol] − [symbol] uₒ

[symbol]

[symbol]

i_{C1} [symbol] =(d−1) [symbol] i_{L1} [symbol] +(d−1) [symbol] i_{L2} [symbol] + [symbol] iᵢₙ

[symbol]

[symbol]

i_{C2} [symbol] =d [symbol] i_{L1} [symbol] +(d−1) [symbol] i_{L2}

[symbol]

[symbol]

uᵢₘ [symbol] = [symbol] u_{C1} [symbol] + [symbol] u_{C2}

[symbol]

[symbol]

uᵢₙ [symbol] = [symbol] u_{C1}

[symbol]

[symbol]

iₒ [symbol] = [symbol] i_{L2} [symbol] (3)

In the above set of equations, the subscripts denote the component the current or voltage of which is denoted by the equation in question. In order to maintain flux linkage and charge balances, the average voltages across the inductors and average currents through the capacitors have to be zero. According to these principles and defining D′=1−D, the operating-point-related steady-state variables become

$${I}_{L 1} = {I}_{in} \\ {I}_{L 2} = \frac{D}{{D}^{′}} {I}_{in} \\ {U}_{C 1} = \frac{D}{{D}^{′}} {U}_{o} \\ {U}_{C 2} = {U}_{o} \\ {U}_{im} = \frac{1}{{D}^{′}} {U}_{o} \\ {U}_{in} = \frac{D}{{D}^{′}} {U}_{o} \\ {I}_{o} = \frac{D}{{D}^{′}} {I}_{in} \qquad ( 4 )$$

which indicates that the input current is reflected to the output multiplied by the duty ratio and divided by its complement (i.e. M(D)=D/D′), and the output voltage to the input with the same conversion ratio. The output voltage is reflected to the intermediate voltage uᵢₘ divided by the complement of the duty ratio. The switching frequency of the converter is assumed to be fₛ and consequently, the cycle time Tₛ=1/fₛ. The duty cycle D=Tₒₙ/T_{off} and, therefore, the length of on-time Tₒₙ=DTₛ and the length of off-time T_{off}=D′Tₛ because Tₛ=Tₒₙ+T_{off}.

The approximate waveforms of the capacitor voltages and inductor currents are shown in FIG. 5. The steady-state values are assumed to be large compared to the peak-to-peak ripple, e.g., only steady-state values affect the ripple slopes. The approximate waveform of the capacitor voltages is shown in FIG. 5 as the curve a) exhibiting triangle shapes. The on-time and off-time slopes of the waveform are denoted by m_{1ci} and −m_{2Ci}. They can be given for the capacitor C₁ by m_{1C1}=Iᵢₙ/C₁ and m_{2C1}=DIᵢₙ/(D′C₁) as well as for the capacitor C₂ by m_{1C2}=Iᵢₙ/C₂ and m_{2C2}=DIᵢₙ/(D′C₂). According to the defined slopes, the peak-to-peak ripples associated to the capacitors can be determined by Δu_{C1-pp}=m_{1Ci}DTₛ. The average voltages are defined in (4). The selection of the capacitors can be based on the defined peak-to-peak ripple and average voltages.

The approximate waveform of the inductor currents is shown in FIG. 5 as the curve b) also exhibiting triangle shapes. The on-time and off-time slopes of the waveform are denoted by −m_{1Li} and m_{2Li}. They can be given for the inductor L₁ by m_{1L1}=Uₒ/L₁ and m_{2L1}=DUₒ/(D′L₁) as well as for the inductor L₂ by m_{1L2}=Uₒ/L₂ and m_{2L2}=DUₒ/(D′L₂). The corresponding peak-to-peak ripple currents can be given by Δi_{Li-pp}=m_{1Li}DTₛ and the corresponding average currents are defined in (4). The selection of the inductors can be based on the defined peak-to-peak ripple and average currents.

In accordance with an exemplary embodiment, when the converter operated in the single PWM mode feeds a DC voltage bus, the control may be carried out in the following manner. Supposing that the power supply feeding the converter is a photovoltaic panel, a maximum power point tracker is used for extracting the maximum available power. The input current and voltage to the converter are measured. These measurements are fed to MPPT device which outputs a reference for the input voltage. The input voltage reference and the measured voltage are fed to a voltage controller which controls the voltage to the desired value by controlling the pulse ratio of the switches to a suitable value.

In accordance with an exemplary embodiment, the output voltage of the converter is limited to a maximum value. If the converter produces higher voltage than the limit, the voltage is lowered by changing the operation point of the converter. This can be carried out by changing the input voltage reference so that the converter no longer operates at the maximum power point. To achieve this, the measured output voltage and the value of the maximum output voltage are fed to a controller, and once the measured voltage exceeds the limit, the controller outputs a control term that is subtracted from the value produced by the MPPT. Of course, other measures can also be used for limiting the output voltage to a suitable level.

### Dual PWM Mode

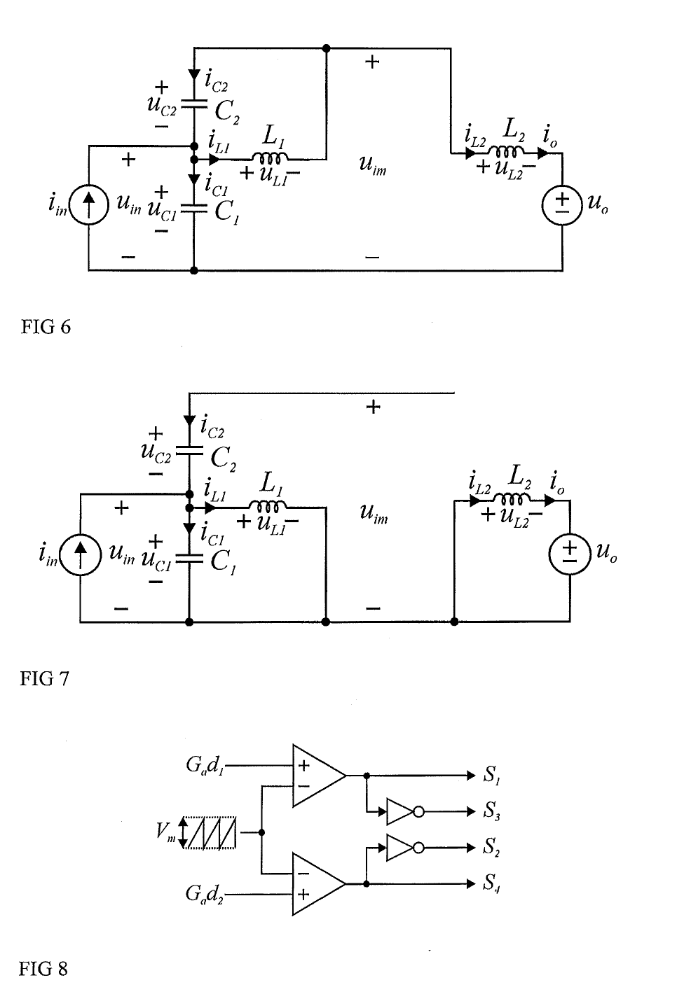

In the dual PWM mode, duty ratios of the superbuck and boost switch pairs (S₁,S₃ and S₂,S₄, respectively) are controlled separately, allowing, for example, dedicated control systems for the output current and input voltage as well as separate control of the intermediate voltage. Besides the on- and off-times of the single PWM converter, the circuit can exhibit two extra states denoted as on-off- and off-on-times. During the on-off-time, the switches S₃ and S₄ are off and the switches S₁ and S₂ are conducting, yielding the on-off-time circuit structure given in FIG. 6. During the off-on-time, the switches S₃ and S₄ are conducting and the switches S₁ and S₂ are off, yielding the off-on-time circuit structure given in FIG. 7.

During the on-off-time we can calculate applying Kirchhoff's laws that

u_{L1}=−u_{C2}

u_{L2}=u_{C1}+u_{C2}−uₒ

i_{C1}=iᵢₙ−i_{L2}

i_{C2}=i_{L1}−i_{L2}

uᵢₘ=u_{C1}+u_{C2}

uᵢₙ=u_{C1}

iₒ=i_{L2} (5)

During the off-on-time we can calculate applying Kirchhoff's laws that

u_{L1}=−u_{C1}

u_{L2}=−uₒ

i_{C1}=iᵢₙ−i_{L1}

i_{C2}=0

uᵢₘ=u_{C1}+u_{C2}

uᵢₙ=u_{C1}

iₒ=i_{L2} (6)

In order to solve the average voltages across the inductors, average currents through the capacitors as well as average input voltage, intermediate voltage and output current, we assume synchronous PWM generation. The switching frequencies are assumed equal as well as the beginning of the on-times. The synchronous PWM generation is realized either by digital control system or comparing the control signals to the same PWM-ramp in analog modulator as depicted in FIG. 8, where Gₐ is the modulator related gain 1/Vₘ and Vₘ is the peak-to-peak value of the PWM-ramp slope, scaling d₁ and d₂ between zero and one.

According to FIG. 8, an extra state appears between on- and off-times when d₁≠d₂. If d₁>d₂, the extra state is the on-off-time, and if d₁<d₂, the extra state is the off-on-time. Now the needed average values can be solved by common average integrals, where Tₛ is the cycle time. For d₁<d₂ we get

$$〈 {u}_{L 1} 〉 = \frac{1}{{T}_{s}} ( {\int }_{0}^{{d}_{1} {T}_{s}} - {u}_{C 2} d t + {\int }_{{d}_{1} {T}_{s}}^{{d}_{2} {T}_{s}} {u}_{C 1} d t + {\int }_{{d}_{2} {T}_{s}}^{{T}_{s}} {u}_{C 1} d t ) \\ 〈 {u}_{L 2} 〉 = \frac{1}{{T}_{s}} ( {\int }_{0}^{{d}_{1} {T}_{s}} - {u}_{o} d t + {\int }_{{d}_{1} {T}_{s}}^{{d}_{2} {T}_{s}} - {u}_{o} d t + {\int }_{{d}_{2} {T}_{s}}^{{T}_{s}} ( {u}_{C 1} + {u}_{C 2} - {u}_{o} ) d t ) \\ 〈 {i}_{C 1} 〉 = \frac{1}{{T}_{s}} ( {\int }_{0}^{{d}_{1} {T}_{s}} {i}_{in} d t + {\int }_{{d}_{1} {T}_{s}}^{{d}_{2} {T}_{s}} ( {i}_{in} - {i}_{L 1} ) d t + {\int }_{{d}_{2} {T}_{s}}^{{T}_{s}} ( {i}_{in} - {i}_{L 1} - {i}_{L 2} ) d t ) \\ 〈 {i}_{C 2} 〉 = \frac{1}{{T}_{s}} ( {\int }_{0}^{{d}_{1} {T}_{s}} {i}_{L 1} d t + {\int }_{{d}_{1} {T}_{s}}^{{d}_{2} {T}_{s}} 0 d t + {\int }_{{d}_{2} {T}_{s}}^{{T}_{s}} - {i}_{L 2} d t ) \\ 〈 {u}_{im} 〉 = 〈 {u}_{C 1} 〉 + 〈 {u}_{C 2} 〉 \\ 〈 {u}_{in} 〉 = 〈 {u}_{C 1} 〉 \\ 〈 {i}_{o} 〉 = 〈 {i}_{L 2} 〉 \qquad ( 7 )$$

For d₁>d₂ we get

$$〈 {u}_{L 1} 〉 = \frac{1}{{T}_{s}} ( {\int }_{0}^{{d}_{2} {T}_{s}} - {u}_{C 2} d t + {\int }_{{d}_{2} {T}_{s}}^{{d}_{1} {T}_{s}} - {u}_{C 2} d t + {\int }_{{d}_{1} {T}_{s}}^{{T}_{s}} {u}_{C 1} d t ) \\ 〈 {u}_{L 2} 〉 = \frac{1}{{T}_{s}} ( {\int }_{0}^{{d}_{2} {T}_{s}} - {u}_{o} d t + {\int }_{{d}_{2} {T}_{s}}^{{d}_{1} {T}_{s}} ( {u}_{C 1} + {u}_{C 2} - {u}_{o} ) d t + {\int }_{{d}_{1} {T}_{s}}^{{T}_{s}} ( {u}_{C 1} + {u}_{C 2} - {u}_{o} ) d t ) \\ 〈 {i}_{C 1} 〉 = \frac{1}{{T}_{s}} ( {\int }_{0}^{{d}_{2} {T}_{s}} {i}_{in} d t + {\int }_{{d}_{2} {T}_{s}}^{{d}_{1} {T}_{s}} ( {i}_{in} - {i}_{L 2} ) d t + {\int }_{{d}_{1} {T}_{s}}^{{T}_{s}} ( {i}_{in} - {i}_{L 1} - {i}_{L 2} ) d t ) \\ 〈 {i}_{C 2} 〉 = \frac{1}{{T}_{s}} ( {\int }_{0}^{{d}_{2} {T}_{s}} {i}_{L 1} d t + {\int }_{{d}_{2} {T}_{s}}^{{d}_{1} {T}_{s}} ( {i}_{L 1} - {i}_{L 2} ) d t + {\int }_{{d}_{1} {T}_{s}}^{{T}_{s}} - {i}_{L 2} d t ) \\ 〈 {u}_{im} 〉 = 〈 {u}_{C 1} 〉 + 〈 {u}_{C 2} 〉 \\ 〈 {u}_{in} 〉 = 〈 {u}_{C 1} 〉 \\ 〈 {i}_{o} 〉 = 〈 {i}_{L 2} 〉 \qquad ( 8 )$$

Both (7) and (8) yield the same averages given by

[symbol]

u_{L1} [symbol] =(1−d) [symbol] u_{C1} [symbol] −d [symbol] u_{C2}

[symbol]

[symbol]

u_{L2} [symbol] =(1−d) [symbol] u_{C1} [symbol] +(1−d) [symbol] u_{C2} [symbol] − [symbol] uₒ

[symbol]

[symbol]

i_{C1} [symbol] =(d−1) [symbol] i_{L1} [symbol] +(d−1) [symbol] i_{L2} [symbol] + [symbol] iᵢₙ

[symbol]

[symbol]

i_{C2} [symbol] =d₁ [symbol] i_{L1} [symbol] +(d₂−1) [symbol] i_{L2}

[symbol]

[symbol]

uᵢₘ [symbol] = [symbol] u_{C1} [symbol] + [symbol] u_{C2}

[symbol]

[symbol]

uᵢₙ [symbol] = [symbol] u_{C1}

[symbol]

[symbol]

iₒ [symbol] = [symbol] i_{L2} [symbol] (9)

In accordance with an exemplary embodiment, in order to maintain flux linkage and charge balances, the average voltages across the inductors and average currents through the capacitors have to be zero. According to these principles the operating-point-related steady-state variables become

$${I}_{L 1} = {I}_{in} \\ {I}_{L 2} = \frac{{D}_{1}}{{D}_{2}^{′}} {I}_{in} \\ {U}_{C 1} = \frac{{D}_{1}}{{D}_{2}^{′}} {U}_{o} \\ {U}_{C 2} = \frac{{D}_{1}^{′}}{{D}_{2}^{′}} {U}_{o} \\ {U}_{im} = \frac{1}{{D}_{2}^{′}} {U}_{o} \\ {U}_{in} = \frac{{D}_{1}}{{D}_{2}^{′}} {U}_{o} \\ {I}_{o} = \frac{{D}_{1}}{{D}_{2}^{′}} {I}_{in} \qquad ( 10 )$$

when D₂′=1−D and D₁′=1−D₁.

The steady-state operating point solution is similar to the single PWM case, but the duty ratios of the superbuck- and boost-parts are separated. It is also noted that now duty ratios have an effect on U_{C2}. The switching frequency of the converter is again assumed to be fₛ and, consequently, the cycle time Tₛ=1/fₛ. When d₁>d₂ the duty cycle D₂=Tₒ/(T_{on-off}+T_{off}) and therefore, the length of on-time Tₒₙ=D₂Tₛ and the length of off-time T_{off}=D₁′Tₛ because Tₛ=Tₒₙ+T_{on-off}+T_{off} and T_{on-off}=D₁Tₛ. When d₁<d₂ the duty cycle D₁=Tₒₙ/(T_{off-on}+T_{off}) and therefore, the length of on-time Tₒₙ=D₁Tₛ and the length of off-time T_{off}=D₂′Tₛ because Tₛ=Tₒₙ+T_{on-off}+T_{off} and T_{off-on}=D₂Tₛ.

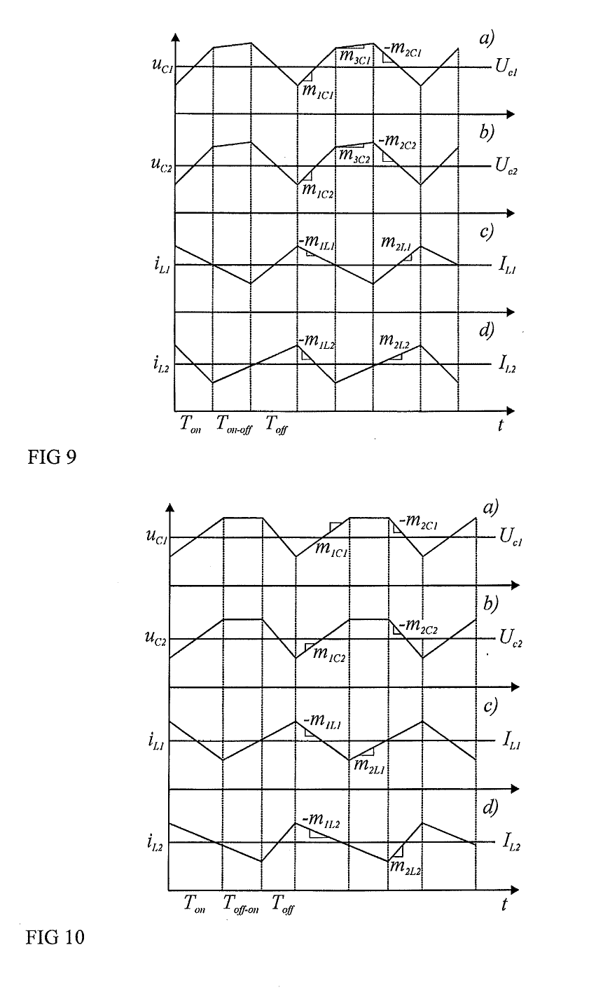

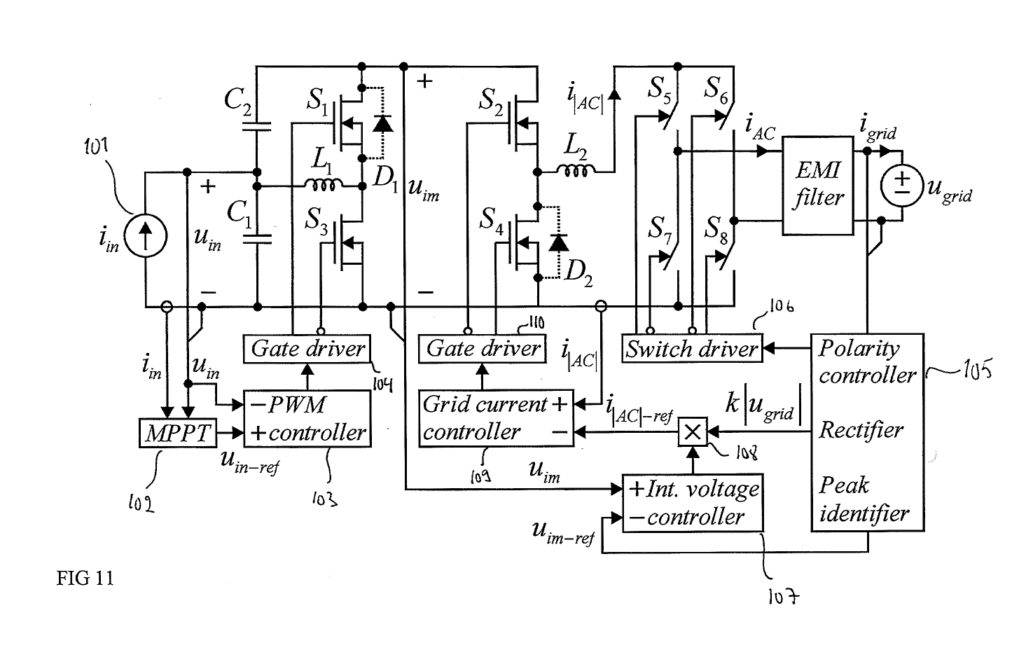

The approximate waveforms of the capacitor voltages and inductor currents are shown in FIG. 9 and FIG. 10 for the corresponding duty ratio relations. The steady-state values are assumed to be large compared to the peak-to-peak ripple, e.g., only steady-state values affect the ripple slopes. The capacitor voltage slopes shown in FIG. 9 and FIG. 10 as the curves a) and b) can be given for the capacitor C₁ by m_{1C1}=Iᵢₙ/C₁, m_{2C1}=D₁Iᵢₙ/(D₂′C₁) and m_{3C1}=(1−D₁/D₂′)Iᵢₙ/C₁ as well as for the capacitor C₂ by m_{1C2}=Iᵢₙ/C₂, m_{2C2}=D₁Iᵢₙ/(D₂′C₂) and m_{3C2}=(1−D₁/D₂′)/Iᵢₙ/C₂.

Note that the slopes m_{3Ci} are negative if D₁>D₂′. When D₁=D₂′, the slopes m_{3Ci} are approximately zero. The capacitor slopes are also approximately zero during the off-on-time. The peak-to-peak ripples associated to the capacitors can be determined according to the defined slopes. When D₁<D₂′, Δu_{Ci-pp}=m_{2Ci}T_{off}, where T_{off}=D₁′Tₛ when d₁>d₂ and T_{off}=D₂′Tₛ when d₁<d₂ When D₁>D₂′, Δu_{Ci-pp}=m_{1Ci}Tₒₙ, where Tₒₙ=D₂Tₛ when d₁>d₂ and Tₒₙ=D₁Tₛ when d₁<d₂. The average voltages are defined in (10). The selection of the capacitors can be based on the defined peak-to-peak ripple and average voltages.

The inductor current slopes shown in FIG. 9 and FIG. 10 as the curves c) and d) can be given for the inductor L₁ by m_{1L1}=D₁′Uₒ/(D₂′L₁) and m_{2L1}=D₁Uₒ/(D₂′L₁) as well as for the inductor L₂ by m_{1L2}=Uₒ/L₂ and m_{2L2}=D₂Uₒ/(D₂′L₂). The corresponding peak-to-peak ripple currents can be given by Δi_{Li}=m_{1Li}Tₒₙ, where Tₒₙ=D₂Tₛ when d₁>d₂ and Tₒₙ=D₁Tₛ when d₁<d₂. The average currents are defined in (10). The selection of the inductors can be based on the defined peak-to-peak ripple and average currents.

When the converter operated in the dual PWM mode feeds a DC voltage bus, the control may be carried out in the following manner. Supposing that the power supply feeding the converter is a photovoltaic panel, a maximum power point tracker can be used for extracting the maximum available power. The input current and voltage to the converter are measured. These measurements are fed to an MPPT device, which outputs a reference for the input voltage. The input voltage reference and the measured voltage are fed to a voltage controller, which controls the voltage to the desired value by controlling the pulse ratio of the switches S₁ and S₃ to a suitable value.

As the switches S₁, S₃ and switches S₂, S₄ are modulated separately, the output voltage can be kept at a desired level by modulating the switches S₂ and S₄.

The above calculations and the waveforms were obtained with synchronized switching periods. It is, however, clear that the switches S₁, S₃ and S₂, S₄ can be modulated completely independently of each other, meaning that even the modulation frequency may not be the same for both switch pairs.

### Grid Interfacing

In the above-described exemplary embodiments, the converter was described as providing voltage to a DC bus. In the following, the topology of the present disclosure is used for supplying power to alternating grid thereby forming effectively an inverter. The transformerless inverter technology is considered to be a low-cost and feasible solution for interfacing solar generator into the grid. The main problems of such solutions are considered to be the high common-mode currents and the fluctuation of the input power at twice the line frequency causing safety problems and reducing the energy harvesting efficiency.

In accordance with an exemplary embodiment, the converter forms a single-phase current-fed solar inverter including a current-fed quadratic buck converter S₁, S₃ and boost converter S₂, S₄, a line-frequency inverter (S₅-S₈), and an EMI filter as shown in FIG. 11.

The buck converter keeps its input voltage constant at the voltage determined by the MPPT device by applying negative feedback control. The boost converter supplies full-wave rectified sinus shaped output current corresponding to the maximum power the input source (e.g., solar generator) can provide. The boost converter keeps its input voltage (e.g., the voltage of the sum of the input capacitors) constant at a level needed for supplying the grid current and determined by the input-voltage-monitoring device. The level can be chosen to minimize the losses in the buck and boost converters. The |AC|/AC inverter works in such a way that the switch pair (S₅,S₇) conducts during the line half cycle when the grid voltage is positive and the switch pair (S₆,S₈) conducts during the line half cycle when the grid voltage is negative. The switches (S₅-S₈) can be implemented by several techniques including MOSFET, IGBT, silicon controlled rectifier, etc. The EMI filter consisting for example of a capacitor and inductor and connected at the output of the |AC|/AC converter removes the switching-frequency noise from the output current.

The current-fed superbuck-boost converter integrated with a line-frequency inverter is a feasible solution for interfacing a solar generator into the single-phase grid without an isolation transformer. The output current of the superbuck-boost is shaped to resemble full-wave rectified grid voltage, which polarity is determined by the line-frequency inverter according to the grid voltage. The voltages imposed over parasitic capacitances from the input source to the neutral conductor are ideally free of high frequency noise, efficiently reducing ground leakage currents, which are considered the main problems in transformerless grid connected photovoltaic applications. An exemplary configuration of the main circuit setup of the inverter with the basic control functions is shown in FIG. 11.

The common-mode voltage created by the proposed circuitry is free of high-frequency noise and half the grid voltage, which effectively reduces the common mode current. The input-voltage controlled of the buck converter effectively reduces the effect of the power fluctuation at the output of the input source down to zero. The intermediate voltage uᵢₘ has to be controlled to be slightly higher than the peak grid voltage but can be optimized in respect to the power losses in the buck and boost stages. The input voltage of the buck converter has to be less than the intermediate voltage, and its minimum level is determined by the minimum usable duty ratio by Uᵢₙ₋ₘᵢₙ=DₘᵢₙU_{DC-max}.

The dual PWM mode described above is used due to its advantages over the single PWM mode. The dedicated input voltage control efficiently reduces the effect of the output power fluctuation in the input with a modest increase in complexity. Smaller input capacitance is required while the energy harvesting efficiency is increased. The buck switch pair (S₁,S₃) is used to keep the input voltage constant at a level determined by the maximum power point tracking (MPPT) device by applying negative feedback control.

The boost switch pair (S₂,S₄) is used to deliver the full-wave rectified sinus shaped output current. It has been observed that high control bandwidths are hard to achieve under direct duty ratio control of the output current with current-fed converters. Dynamic analysis of the dual PWM superbuck-boost converter reveals a right-half-plane (RHP) zero in the control-to-output related transfer functions of the boost-part limiting the control bandwidth. The RHP zero is a characteristic property of a boost converter, whether voltage-fed or current-fed. A positive feedback output current loop unstabilizes the converter but allows high bandwidth current reference tracking while the intermediate voltage uᵢₘ keeps at adequate levels. Now it can be observed that the converter may be stablized by another positive feedback loop from the intermediate voltage. After addition of the current loop, the dynamic analysis reveals a RHP pole in the output-current-reference-to-intermediate-voltage transfer function. According to system theory, the converter is stable when the intermediate voltage loop bandwidth exceeds the RHP pole frequency. Naturally, the input voltage controller affects also the dynamics of the boost-part.

The intermediate voltage has to be kept at a level higher than the peak grid voltage. The grid voltage peak identifier determines the intermediate voltage reference to allow operation with various grid voltages. The level can be chosen to minimize the losses in the converter with a transient margin. The line-frequency inverter works in such a way that the switch pair S₅,S₈ conducts during the positive half of the grid voltage line cycle and the switch pair S₆,S₇ conducts during the line cycle half when the grid voltage is negative. Low conduction loss devices are recommended. The EMI filter connected at the output attenuates the switching frequency noise of the output current and ensures the EMC-compatibility of the inverter.

The control system of the inverter according to an exemplary embodiment of the present disclosure is described next with reference to FIG. 11. A current source 101, such as a photo voltaic panel, string or array, is connected to the input of the inverter. The current source produces input current iᵢₙ, which is measured together with the input voltage uᵢₙ. The measured values are fed to a maximum power point tracker 102, which calculates a reference value for the input voltage u_{in-ref}. When such a voltage is obtained to the input of the inverter, the PV panel is operated at is maximum power point and all available power is extracted from the panel.

The input voltage reference u_{in-ref} is fed to a PWM controller 103 together with the measured input voltage uᵢₙ. The controller 103 produces a duty ratio for gate driver 104, which controls the switches S₁ and S₃ according to the obtained duty ratio for controlling the input voltage to correspond to the reference voltage. The switches S₁ and S₃ thus effectively control the input voltage to the reference voltage, which is obtained from the measured input current using an MPP algorithm.

In the inverter according to the exemplary embodiment, the grid voltage u_{grid} is also measured. The measured voltage value is fed to block 105. Block 105 serves as a polarity controller for the inverter which is synchronized to the grid voltage. The polarity controller outputs the information of the polarity of the grid voltage to switch driver 106 which controls switches S₅ and S₈ conductive when the grid voltage is positive and switches S₆ and S₇ conductive when the grid voltage is negative.

Block 105 also includes a rectifier for obtaining the rectified sinusoidal shape of the grid voltage. The grid voltage is rectified and scaled by multiplying it with a constant k.

Further, block 105 includes a peak identifier, which identifies the amplitude of the grid voltage for producing a reference value U_{im-ref} for the intermediate voltage. The intermediate voltage uᵢₘ is measured and fed to an intermediate voltage controller 107 together with the reference value u_{im-ref}. The output of the voltage controller 107 is fed to a multiplier block 108 which multiplies the output and the scaled and rectified value of the grid voltage k|_{grid}| for producing a reference for the rectified value of grid current i_{|Ac|-ref}. This reference value is fed to a grid current controller 109, which also receives measured grid current value i_{|AC|}. The measured value is also rectified value since it is measured before the inverting switches. Grid current controller 109 outputs a pulse ratio for gate driver 110, which controls switches S₂ and S₄ according to the pulse ratio for keeping the intermediate voltage at its reference value and for producing a current having a rectified sinusoidal shape in synchronism with the grid voltage.

To easily demonstrate the low frequency behaviour of the inverter in FIG. 1, time domain simulations in steady-state have been carried out with a switching frequency averaged model (e.g., the switching frequency ripple is removed from the waveforms). The parameters used in the simulation are listed in Table 1.

TABLE 1
Simulation parameters.

| u_{in-ref} | u_{im-ref} | U_{grid} | iᵢₙ | C₁ | C₂ | C₃ | L₁ | L₂ |
|---|---|---|---|---|---|---|---|---|
| 25 V | 360 V | 230 V | 7.5 A | 22 μF | 440 μF | 22 μF | 220 μH | 1 mH |

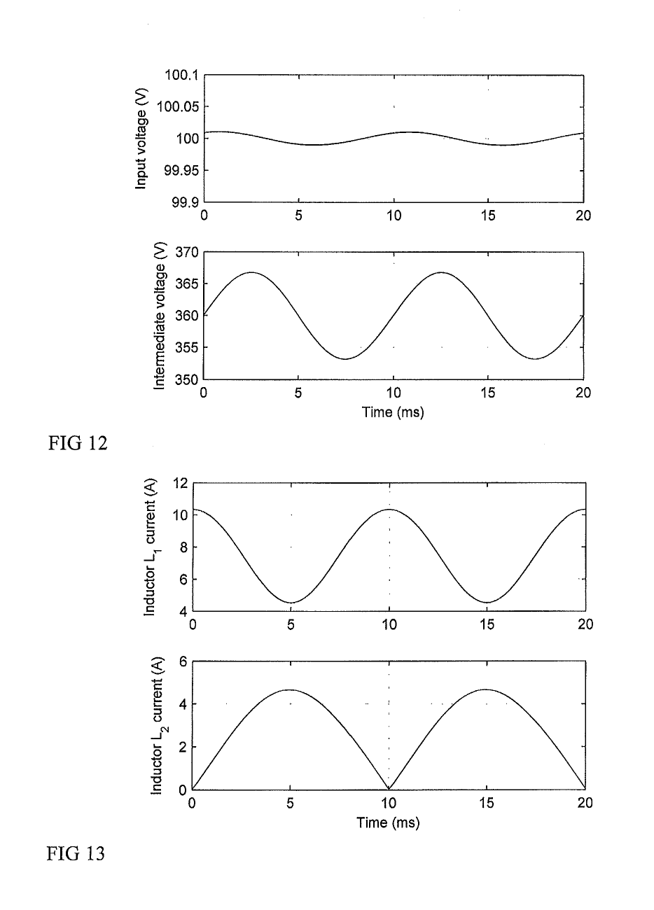

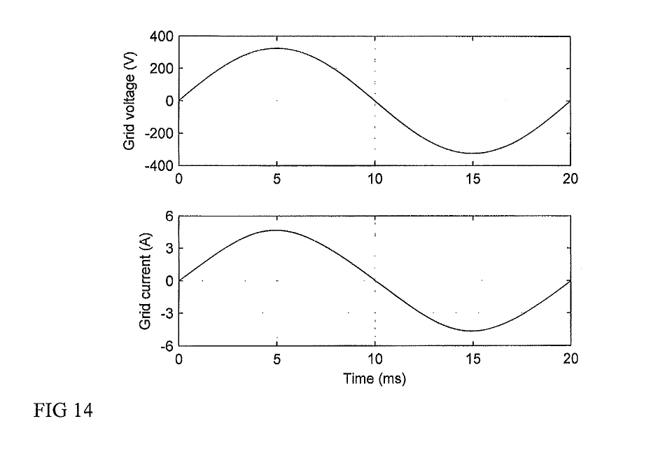

FIG. 12 shows the input and intermediate voltages according to an exemplary embodiment of the present disclosure. As can be seen, the input voltage ripple at twice the grid frequency can be controlled to negligibly small values. The voltage ripple at the intermediate voltage is similar to the input voltage ripple in any common grid-connected single-phase photovoltaic inverter. The low-frequency ripple current of the capacitor C₁ is steered to the inductor L₁ as can be seen in FIG. 13 with the full-wave-rectified shaped current of the inductor L₂. The resulting grid current with the grid voltage is shown in FIG. 14.

In order to design the inverter properly, the low frequency ripples need to be solved. The switching frequency ripples were analyzed above in connection with the converter structure. The variables in angle brackets are the switching frequency averaged values. The low frequency ripples can be approximated by calculating the power fluctuation caused by the sinusoidal grid variables. The grid current controller injects sinusoidal current to the grid at unity power factor. The grid angular frequency is denoted by ωₒ. At steady-state

[symbol]

P_{grid} [symbol] =\sqrt{2}U_{grid} sin(ω₀t)\sqrt{2}I_{grid} sin(ω₀t)=2P_{grid} sin²(ω₀t) (11)

According to the trigonometric double-angle formulas sin²(x)=(1−cos(2x))/2. Now it is seen that the power fluctuates at twice the grid frequency. Given as a function of the input power and efficiency of the converter, denoted by η, steady-state grid power is

[symbol]

P_{grid} [symbol] =ηPᵢₙ(1−cos(2ω₀t)) (12)

Since the input voltage controller keeps the input voltage constant, the average current through the capacitor C₁ is zero. Accordingly, the power fluctuation imposed low frequency current appears only through the capacitor C₂. At steady-state the DC-component must be zero in order to maintain the charge balance. If the ripple voltage over the capacitor C₂ is assumed small compared to the dc-component, we get (13) applying the current directions of FIG. 2.

$$〈 {i}_{C 2} 〉 = \frac{η {P}_{in}}{( {U}_{im} - {U}_{in} )} cos ( 2 {ω}_{0} t ) \qquad ( 13 )$$

According to the basic circuit theory, the inductor voltages and capacitor currents can be presented as

$${u}_{L} = L \frac{d {i}_{L}}{d t} and {i}_{C} = C \frac{d {u}_{C}}{d t} ,$$

respectively. The voltage ripple over the capacitor C₂ which is also the voltage ripple of the intermediate voltage, is

$$〈 {u}_{C 2 - ripple} 〉 = \frac{η {P}_{in}}{2 {ω}_{0} {C}_{2} ( {U}_{im} - {U}_{in} )} sin ( 2 {ω}_{0} t ) \qquad ( 14 )$$

Since the input current is constant, [symbol] i_{C1} [symbol] =0 and [symbol] i_{L1} [symbol] = [symbol] iᵢₙ [symbol] + [symbol] i_{C2} [symbol] − [symbol] i_{C1} [symbol] , the ripple current through the inductor L₁ is simply

$$〈 {i}_{L 1 - ripple} 〉 = 〈 {i}_{C 2} 〉 = \frac{η {P}_{in}}{( {U}_{im} - {U}_{in} )} cos ( 2 {ω}_{0} t ) \qquad ( 15 )$$

In order to keep the input voltage constant and power flow towards the grid, the ripple current amplitude of the inductor L₁ must not exceed the input current.

It is to be understood that the converter also includes means for controlling the semiconductor components. These means comprise suitable drive circuitry able to control the components to a conductive and blocking state. Drive circuitry includes, for example, auxiliary power sources, modulators and other peripheral circuits. It is also clear that the above-mentioned controller for current and voltage control are implemented in a manner known by a skilled person. Further, the maximum power point tracker used may be of any available type as long as it produces a reference value for the input voltage. In the above description, referring to drawings, some of the features are incorporated in blocks. It is clear that the functionality required for the present disclosure can be structured in functional blocks other than the ones described above and in the drawings.

The converter of the present disclosure is described above mainly in connection with a photovoltaic panel. It is clear that the power source feeding current to the current-fed converter may be of any other type, such as a superconducting magnetic energy storage (SMES).

It will be obvious to a person skilled in the art that, as the technology advances, the inventive concept can be implemented in various ways. The present disclosure and its embodiments are not limited to the examples described above but may vary within the scope of the claims.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

1. A converter circuit comprising:
first and second input terminals for receiving an input current from a current source;
a first capacitor connected between the first and second input terminals;
a second capacitor having a first terminal connected to the second input terminal, and a second terminal forming a positive voltage node;
first and third semiconductor components connected in series between the first input terminal and a positive voltage node, a midpoint between the series connection forming a first node;
a first inductive component connected between the second input terminal and the first node;
second and fourth semiconductor components connected in series in parallel with the series connection between the first and third semiconductor components; and
a second inductive component having a first end which is connected to a second node formed between the second and fourth semiconductor components, and a second end which forms a first output terminal, the first input terminal forming a second output terminal,
wherein the first and the third semiconductor components are configured to control a voltage between the first and second input terminals.

2. A converter according to claim 1, wherein the first and fourth semiconductor components are respectively one of a diode and a switch component, and the second and third semiconductor components are switch components.

3. A converter according to claim 1, comprising:
means for controlling the semiconductor components.

4. A converter according to claim 3, wherein the means for controlling the first and third semiconductor components is configured to control the voltage between the first and second input terminals based on the input current.

5. A converter according to claim 4, comprising:
a maximum power point tracking device configured to provide a voltage reference for the input voltage.

6. A converter according to claim 1, wherein the first and third semiconductor components comprise a first semiconductor pair, the second and fourth semiconductor components comprise a second semiconductor pair, and the first and second semiconductor pairs receive the same control.

7. A converter according to claim 1, wherein the first and third semiconductor components comprise a first semiconductor pair, the second and fourth semiconductor components comprise a second semiconductor pair, the first and second semiconductor component pairs receive different control, and the second and fourth semiconductor components are configured to control the voltage of the series connection of the first and second capacitors.

8. A converter according to claim 7, comprising:
a controlled inverter connected to the first and second output terminals of the converter for feeding power to a single phase alternating grid;
means for determining a polarity of the voltage of the grid;
means for producing a signal representing a pulse shape of a rectified grid voltage;
means for determining a peak voltage of the grid voltage;
means for controlling the voltage of a sum of the first and second capacitors such that current is feedable to the grid; and
means for controlling the second and fourth semiconductor components such that an output current from the controlled inverter is in phase with the grid voltage.

9. A method for controlling a converter, wherein the converter includes:
first and second input terminals for receiving an input current from a current source;
a first capacitor connected between the first and second input terminals;
a second capacitor having a first terminal connected to the second input terminal, and a second terminal forming a positive voltage node;
first and third semiconductor components connected in series between the first input terminal and a positive voltage node, a midpoint between the series connection forming a first node;
a first inductive component connected between the second input terminal and the first node;
second and fourth semiconductor components connected in series in parallel with the series connection between the first and third semiconductor components; and
a second inductive component having a first end which is connected to a second node formed between the second and fourth semiconductor components, and a second end which forms a first output terminal, the first input terminal forming a second output terminal, and
wherein the method comprises:
measuring the input current and an input voltage;
generating a voltage reference for the input voltage; and
controlling the first and third semiconductor components in response to the measured voltage and voltage reference.

10. A method for controlling the converter according to claim 9, wherein the first and third semiconductor components comprise a first semiconductor pair, the second and fourth semiconductor components comprise a second semiconductor pair, the first and second semiconductor component pairs receive different control, and the second and fourth semiconductor components are configured to control the voltage of the series connection of the first and second capacitors,
wherein the converter includes a controlled inverter connected to the first and second output terminals of the converter for feeding power to a single phase alternating grid, and wherein the method comprises:
measuring voltage of the grid;
rectifying and scaling the grid voltage;
measuring voltage of the series connection of the first and second capacitors;
producing a reference value for the voltage of the series connection of the first and second capacitors;
measuring current of the output of the converter; and
controlling the second and fourth semiconductor components based on the measured voltage of the series connection of the first and second capacitors, the reference value for the voltage of the series connection of first and second capacitors, a rectified and scaled grid voltage, and the measured output current of the converter for producing output current from the controlled inverter that has the same phase and shape as the grid voltage.

11. A converter according to claim 3, wherein the first and third semiconductor components comprise a first semiconductor pair, the second and fourth semiconductor components comprise a second semiconductor pair, and the first and second semiconductor pairs receive the same control.

12. A converter according to claim 5, wherein the first and third semiconductor components comprise a first semiconductor pair, the second and fourth semiconductor components comprise a second semiconductor pair, and the first and second semiconductor pairs receive the same control.

13. A converter according to claim 3, wherein the first and third semiconductor components comprise a first semiconductor pair, the second and fourth semiconductor components comprise a second semiconductor pair, the first and second semiconductor component pairs receive different control, and the second and fourth semiconductor components are configured to control the voltage of the series connection of the first and second capacitors.

14. A converter according to claim 13, comprising:
a controlled inverter connected to the first and second output terminals of the converter for feeding power to a single phase alternating grid;
means for determining a polarity of the voltage of the grid;
means for producing a signal representing a pulse shape of a rectified grid voltage;
means for determining a peak voltage of the grid voltage;
means for controlling the voltage of a sum of the first and second capacitors such that current is feedable to the grid; and
means for controlling the second and fourth semiconductor components such that an output current from the controlled inverter is in phase with the grid voltage.

15. A converter according to claim 5, wherein the first and third semiconductor components comprise a first semiconductor pair, the second and fourth semiconductor components comprise a second semiconductor pair, the first and second semiconductor component pairs receive different control, and the second and fourth semiconductor components are configured to control the voltage of the series connection of the first and second capacitors.

16. A converter according to claim 15, comprising:
a controlled inverter connected to the first and second output terminals of the converter for feeding power to a single phase alternating grid;
means for determining a polarity of the voltage of the grid;
means for producing a signal representing a pulse shape of a rectified grid voltage;
means for determining a peak voltage of the grid voltage;
means for controlling the voltage of a sum of the first and second capacitors such that current is feedable to the grid; and
means for controlling the second and fourth semiconductor components such that an output current from the controlled inverter is in phase with the grid voltage.
